(19) United States
(12) Patent Application Publication
(10) Pub. No.: US 2006/0215403 A1
(43) Pub. Date: Sep. 28, 2006

(54) Combination exit sign and emergency lighting fixture assembly

(75) Inventor: Patrick Martineau, lle-Perrot (CA)

Correspondence Address: HOFFMANN & BARON, LLP, 6900 JERICHO TURNPIKE, SYOSSET, NY, 11791, US

(73) Assignee: Thomas & Betts International, Inc.

(21) Appl. No.: 11/384,949

(22) Filed: Mar. 20, 2006

Related U.S. Application Data
(60) Provisional application No. 60/664,075, filed on Mar. 22, 2005.

(51) Int. Cl. F21V 1/00; F21V 11/00

(52) U.S. Cl. 362/240

(57) ABSTRACT

A combination exit sign and emergency lighting fixture includes a sign fixture and an emergency light fixture. The sign fixture includes a sign housing having a perimetrical wall defining opposed spaced apart faces. The perimetrical wall supports at at least one face an illuminable sign. The emergency lighting fixture includes at least one illuminative emergency light attached to the perimetrical wall. A light housing is sealingly secured to the perimetrical wall and encloses the emergency light. The light housing has a transverse extent not exceeding the outermost transverse extent of the opposed spaced apart spaces. Illumination means is provided within the sign housing for illuminating the sign and the emergency light.

### CROSS-REFERENCE TO RELATED APPLICATIONS

This application claims the benefit of U.S. Provisional Patent Application Serial No. 60/664,075 filed on Mar. 22, 2005.

### TECHNICAL FIELD

The present invention relates generally to a lighting fixture assembly. More particularly, the present invention relates to a combination exit sign and emergency lighting fixture.

### BACKGROUND OF THE INVENTION

The need for emergency lighting and illuminated signage, such as exits signs, in buildings and other public areas is often mandated by building and safety codes. One common lighting fixture assembly which is used in emergency lighting situations is known as a combination light. This light combines exit signs together with emergency lights. In the event of an emergency, the exit sign is illuminated to identify an exit, while the emergency lights operate to supply an acceptable degree of illumination under emergency conditions, such as loss of power. Since the exit sign and the emergency lighting must operate in absence of main power, back-up power is provided to the assembly by batteries and associated electronics which switches the sign from normal AC power to back-up DC power.

The use of such combination emergency lighting and exit signs, commonly referred to as combos, is prevalent. One example of such an assembly is shown in U.S. Pat. No. 5,979,673 where an exit sign includes a pair of emergency lights mounted on either side of the exit sign. Another such arrangement is shown in U.S. Pat. Design No. 406,279 where a pair of emergency lights are mounted over the exit sign.

As may be appreciated, these combo assemblies may be positioned at various locations within a building where, upon loss of main power, it would be necessary to illuminate the area and provide an indication of the closest exit. As such, these signs are typically mounted to a wall or ceiling in main thoroughfares within the building. For both aesthetics and to assure proper mounting, it is desirable that the combo assembly be of relatively compact configuration. Moreover, since the combo assembly should remain illuminated in adverse conditions, the assembly of the exit sign and the emergency should be sealed.

Many of the existing combo assemblies attach separate emergency lights to the housing which supports the exit sign. This results in the overall assembly being bulky and difficult to adequately mount in an aesthetically pleasing location. Furthermore, as the emergency lights are attached and extend from the exit sign, the sealing of the components against adverse conditions is difficult. Moreover, the combination assembly must accommodate the illumination electronics including a DC power source, further adding to the overall size of the assembly.

It is, therefore, desirable to provide a combination exit and emergency lighting fixture which provides both exit signage and emergency lighting in a compact sealed assembly.

### SUMMARY OF THE INVENTION

The present invention provides a combination exit and emergency lighting fixture including a sign fixture. The sign fixture includes a sign housing having a perimetrical wall defining opposed spaced apart faces. The perimetrical wall supports on at at least one face, an illuminable sign in sealed relationship. The emergency lighting fixture includes at least one illuminable emergency light attached to the perimeterical wall. A light housing is sealingly secured to the perimetrical wall and encloses the emergency light. The light housing has a transverse extent not exceeding the outermost transverse extent of the opposed spaced apart faces of the sign housing. Illumination means is contained within the sign housing for illuminating the sign and the emergency light.

In a preferred embodiment of the present invention, the exit and emergency lighting fixture includes an exit sign fixture. The exit sign fixture includes a sign housing having a perimetrical wall defining opposed faces transversely spaced apart a given distance and which support thereat in sealed relationship a pair of illuminable exit signs. An emergency lighting fixture includes at least one illuminable emergency light secured to the perimetrical wall. A light housing sealingly secured to the perimetrical wall encloses the emergency light. The housing has a transverse extent not exceeding the given distance between the opposed faces of the exit light fixture. Illumination means is contained within the sign housing for illuminating the exit sign in the emergency light.

It is further contemplated that the exit signs define a peripheral boundary where the perimetrical wall of the housing substantially co-extensively bounds the peripheral boundary. Moreover, the emergency lighting fixture may be adjustably secured to the perimetrical wall of the fixture housing.

### BRIEF DESCRIPTION OF THE DRAWINGS

FIG. 1 is a front plan view of the exit sign and emergency lighting fixture assembly of the present invention.

FIG. 2 is an exploded perspective view of one embodiment of the exit sign and emergency lighting fixture assembly of the present invention.

FIG. 3 is a sectional showing of the assembly of FIG. 2.

FIG. 4 is an exploded perspective view of a component of the assembly of FIG. 2.

FIG. 5 is an exploded perspective view of a further embodiment of the exit sign and emergency lighting fixture assembly of the present invention.

FIG. 6 is a sectional showing of the assembly of FIG. 5.

FIG. 7 is an exploded perspective view of a component of the assembly of FIG. 5.

FIGS. 8-11 show in plan view, alternative mounting arrangements of different embodiments of the assembly of the present invention.

### DETAILED DESCRIPTION OF THE PREFERRED EMBODIMENTS

The present invention provides a combination exit sign and emergency lighting fixture which is mountable to a wall or a ceiling and is of compact configuration and supports the components in a sealed arrangement.

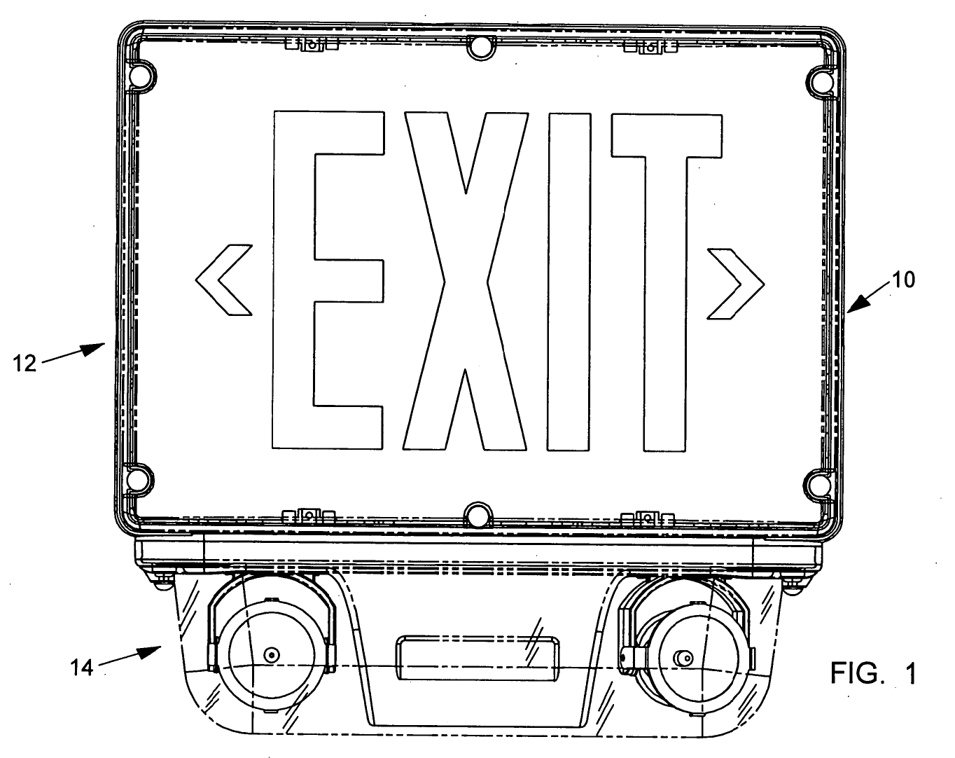

Referring to FIG. 1, the lighting fixture assembly 10 of the present invention is shown. Lighting fixture assembly 10 includes in combination an illuminable exit sign fixture 12 and an emergency light fixture 14. The use of illuminable exit signs together with emergency lighting is well known and the assembly is commonly referred to as a “combo” assembly.

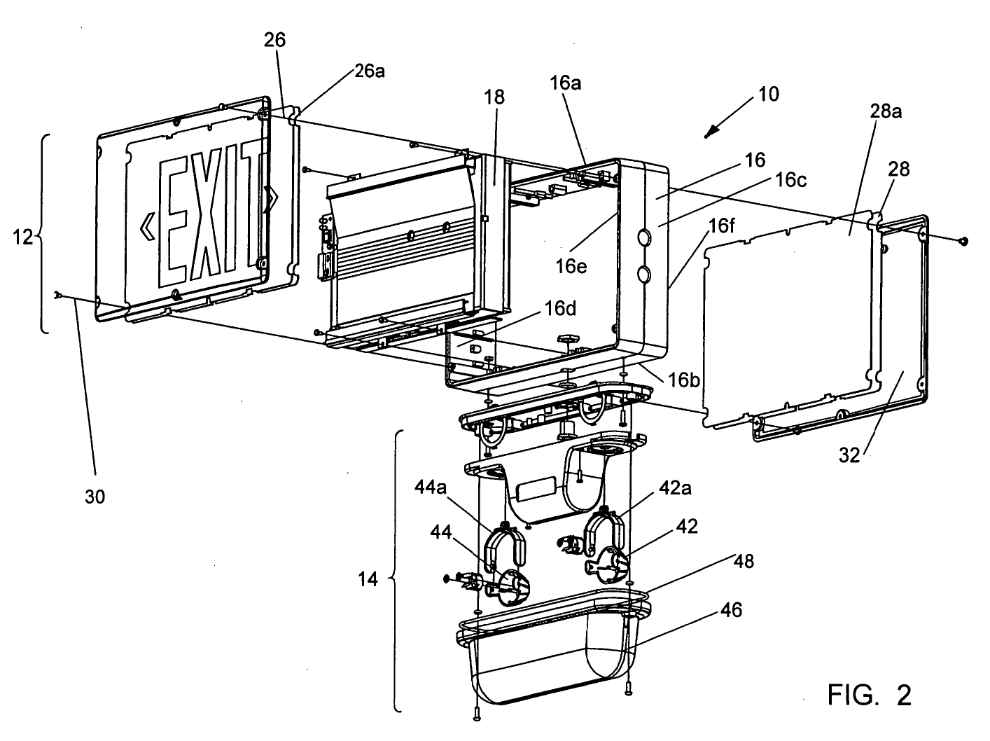

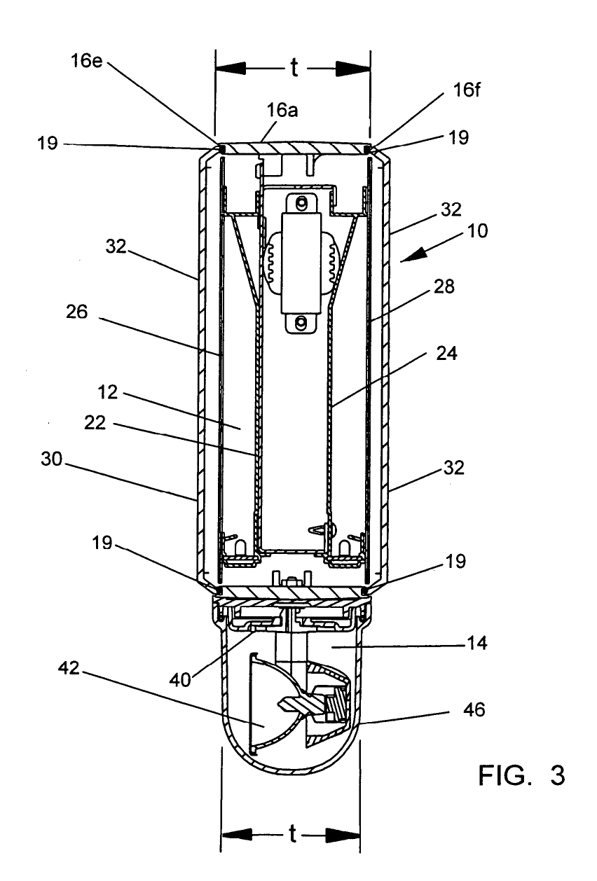

Referring additionally to FIGS. 2 and 3, the combo assembly 10 is shown in exploded condition. The assembly includes a sign fixture 12 with lighting fixture 14 mounted thereto in depending fashion. Sign fixture 12 includes a fixture housing 16 which is formed in a generally rectangular configuration having upper and lower walls 16a and 16b and opposed side walls 16c and 16d. Collectively, the housing 16 defines a generally rectangular perimetrical structure having opposed open faces 16e and 16f.

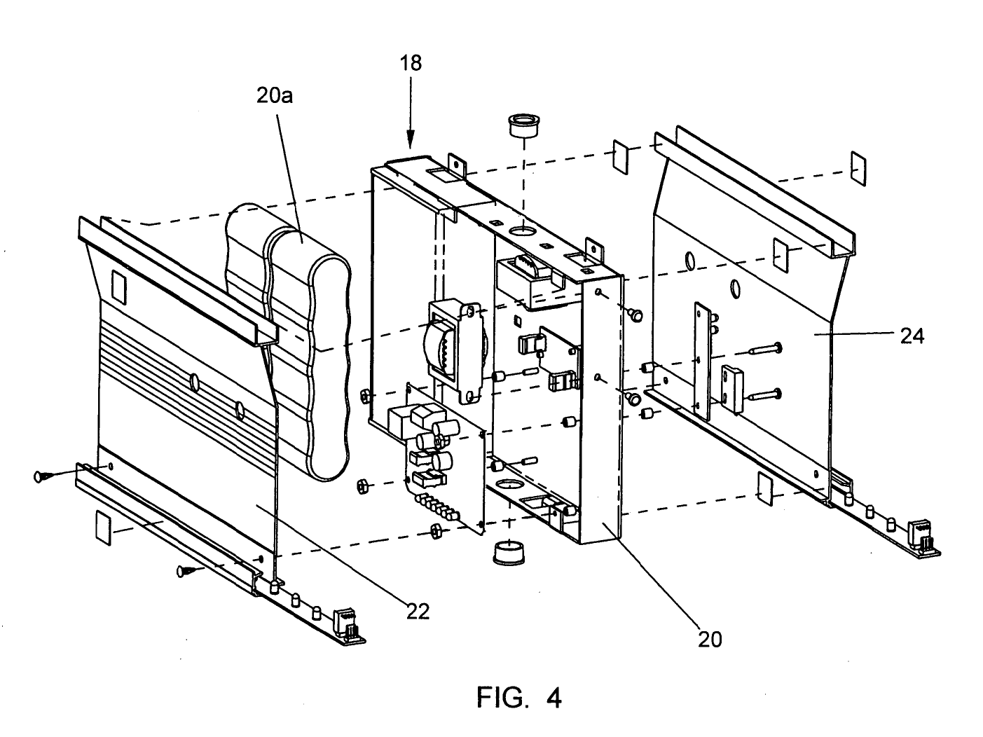

The fixture housing 16 supports therein an electronic subassembly 18 shown in further detail in FIG. 4. The subassembly 18 includes a subassembly housing 20 which supports therein a plurality of electronic components for providing standby power for illumination of both the sign fixture 12 and lighting fixture 14. Such electronics may include a DC battery 20a and various other electronic components which are well known to operate the combo assembly 10 under emergency lighting conditions. The subassembly 18 further includes a pair of extrusions 22 and 24 supported on opposed sides of subassembly 18. The extrusions 22, 24 enclose the subassembly 18 and each provide for mounting of an exit sign thereto.

Referring again to FIGS. 2 and 3, a pair of generally rectangular planar exit signs 26 and 28 may be supported on extrusions 22 and 24, respectively. The exit signs 26, 28 are mounted such that they are supported on the opposite faces 16e, 16f of housing 16. Each extrusion may also support a diffuser 26a and 28a behind the exit signs as is well known in the art. Moreover, the fixture housing 16 further supports a lens 30 and 32, respectively, over exit signs 26 and 28. The lens is secured to the fixture housing 16 with screws. A gasket 19 in between the fixture housing 16 and the lens 30 and 32, provides a sealed enclosure for the subassembly 18.

As is particularly shown in FIGS. 1, 2 and 3, the exit signs 26, 28 occupy the entire facing surfaces of fixture housing 16. Thus, there is little or no housing border about the actual exit signs. Furthermore, all of electronics, including the power supply contained within subassembly 18, is housed directly between the oppositely facing exit signs 26, 28. This allows for compact configuration of the sign fixture 12.

The combo assembly 10 further includes lighting fixture 14 which in a preferred embodiment is attached to and depending from bottom wall 16b of fixture housing 16. However, it may be appreciated that the lighting fixture 14 may be attached to any of the other walls of housing 16, depending upon the particular application. The light fixture 14 includes a lighting subassembly housing 40 which is attached to the bottom wall 16b of housing 16. The housing 40 supports a pair of swivel lamps 42 and 44 mounted with swivel mechanisms 42a and 44a to housing 40. A lens 46 encloses the lamps 42 and 44 and is secured to the housing 40 in sealed fashion by a gasket 48. Thus, the lamps are sealed to housing 16.

As particularly shown in FIG. 3, the entire lighting fixture 14 including the lamps 42, 44 and the lens 46 has a transverse dimension t. This transverse dimension, preferably, does not exceed the transverse dimension of the sign fixture 12 measured in the same direction. In some preferred embodiments, the two transverse dimensions are approximately equal and preferably the lighting fixture transverse dimension is less. Thus, the combo assembly provides a “slim” profile not found in prior art devices. This slim profile allows the combo assembly 10 to be mounted to a wall or ceiling in close proximity thereto.

Another advantage of the present invention may relate to omni-directional lamp aiming. For example, when the combination assembly of the present invention is end mounted or ceiling mounted, the lamp can be oriented to illuminate any side of the unit and thereby, provide aiming versatility.

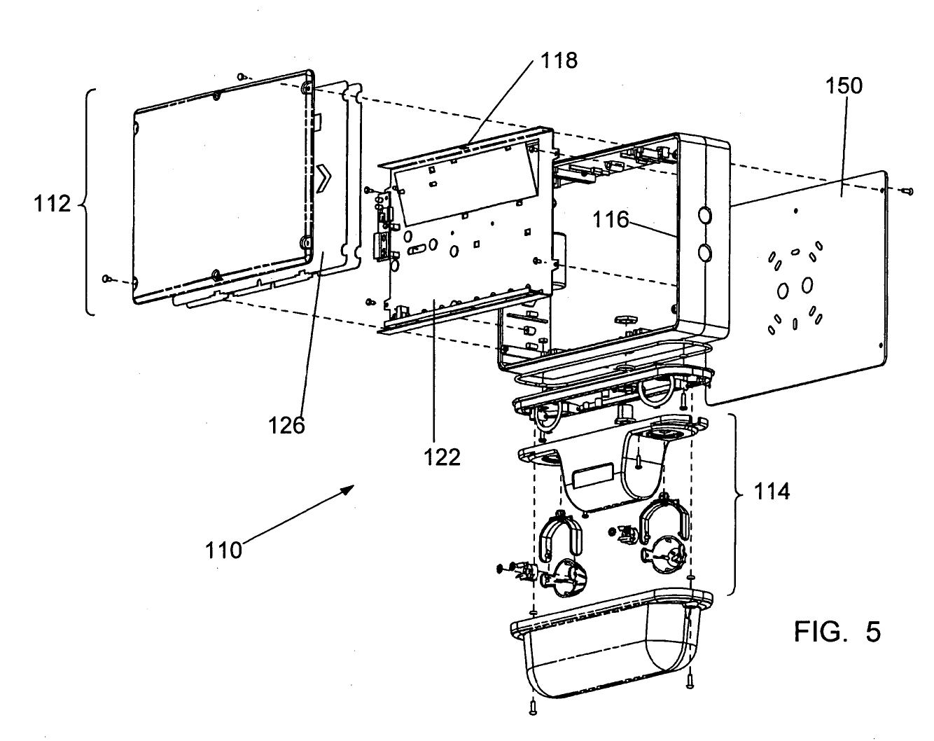

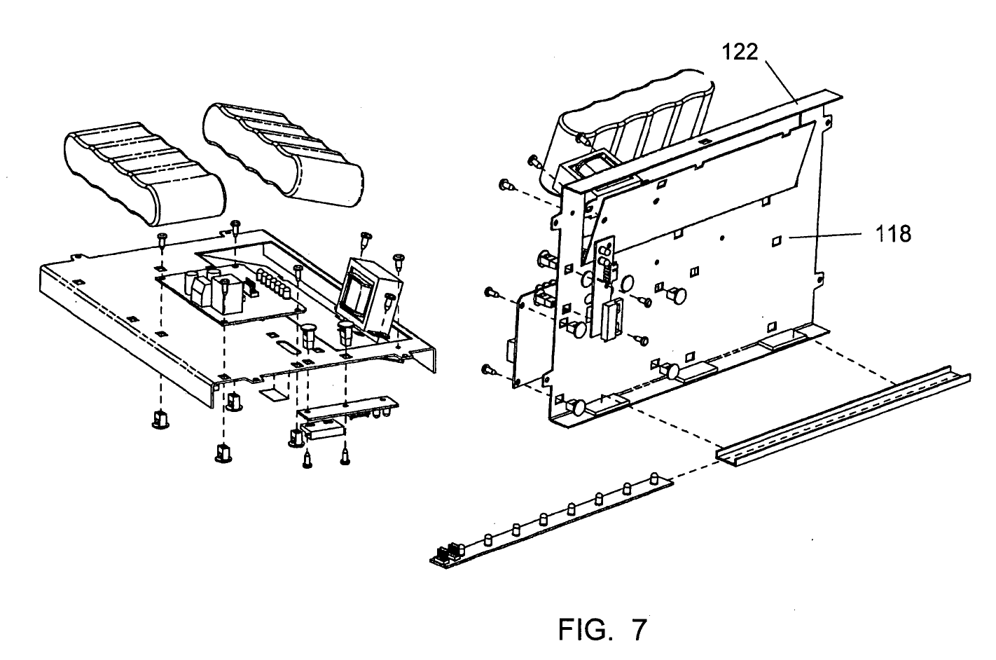

In FIGS. 5, 6 and 7, a further embodiment of the combo assembly of the present invention is shown. Combo assembly 110 is substantially similar to combo assembly 10 shown in FIGS. 1-4 and similar components need not be discussed here. Combo assembly 110 includes a sign fixture 112 which includes a subassembly 118. In the present embodiment, subassembly 118 supports a single exit sign 126 on one side of subassembly 118. A single frame 122 supports the sign 126. The subassembly 118 also supports the associated electronics as shown in FIG. 5. The opposite side of housing 116 supports a flat rear mounting panel 150. Combo assembly 110 is used in situations where the assembly is mounted against a wall and there is no need for a second exit sign at the rear portion thereof. In all other respects, combo assembly 110 is identical to that shown in FIGS. 1-4.

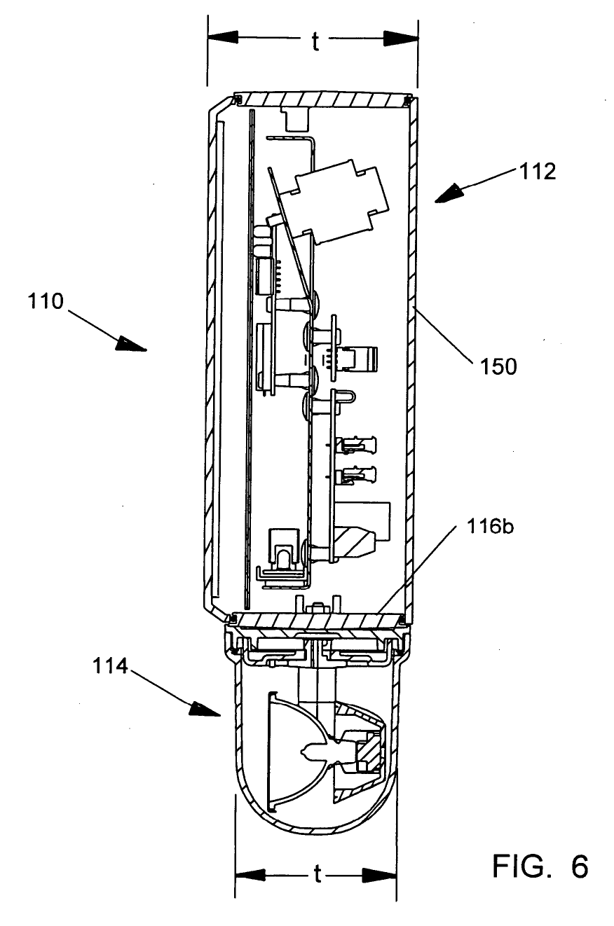

As with the prior embodiment, the exit sign and the rear back panel occupy the entire facing surfaces of the fixture housing 116 providing little or no border therearound. All of the electronics are contained within subassembly 118 and housed between exit sign 126 and back panel 150, again allowing for compact configuration. Furthermore, as shown in FIG. 6, the lighting fixture 114 which depends from bottom wall 116b maintains a transverse dimension t which does not greatly exceed the transverse dimension of the sign fixture 112 measured in the same direction and preferably is equal to or les than the transverse dimension of sign fixture 112.

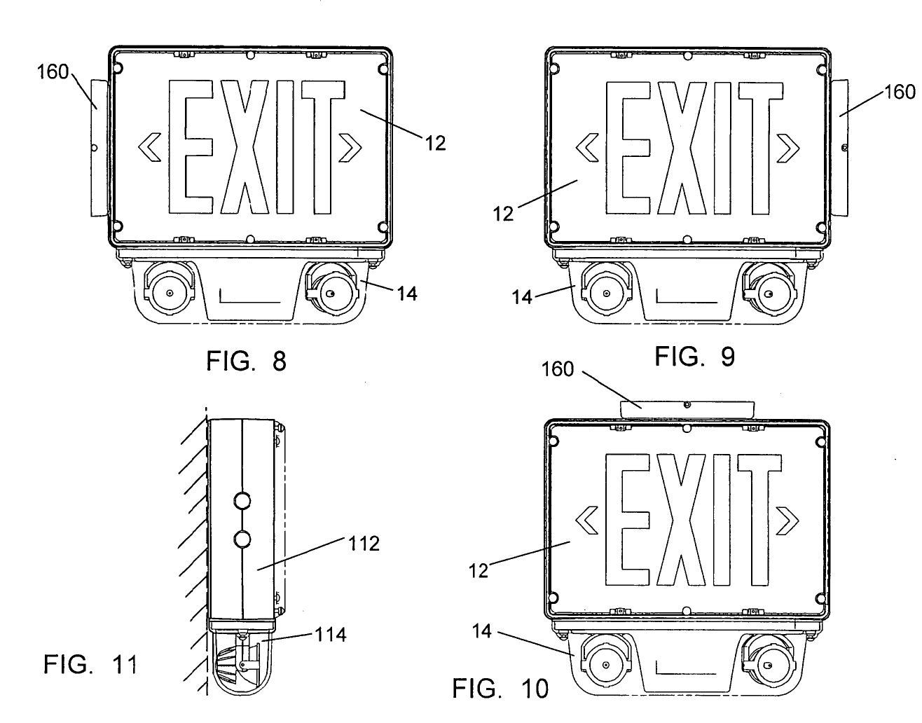

Referring now to FIGS. 8-11, various alternative mounting arrangements are shown with respect to the combo assembly 10. For example, as shown in FIGS. 8 and 9, the combo assembly may be mounted to a wall using a mounting canopy 160 secured to either side 16c or 16id of housing 16. Moreover, as shown in FIG. 10, the canopy 160 may be supported to the upper wall 16a of housing 16 so as to mount the combo assembly to a ceiling. As shown in FIG. 11, specifically with respect to the embodiment of the invention described in FIGS. 5-7, the combo assembly may be mounted directly to a wall. In each of the embodiments shown in FIGS. 8-11, the combo assembly maintains its compact configuration with the lighting fixture transverse dimension generally not exceeding the transverse dimension of the sign fixture so as to provide for compact mounting of the combo assembly.

What is claimed is:

1. A combination exit sign and emergency lighting fixture assembly comprising:
a sign fixture including a sign housing having a perimetrical wall defining opposed spaced apart faces, said perimetrical wall supporting at least one face of an illuminable sign;
an emergency lighting fixture including at least one illuminable emergency light attached to said perimetrical wall, and a light housing sealingly secured to said perimetrical wall and enclosing said emergency light, said lighting fixture having a transverse dimension not exceeding the transverse dimension of said sign fixture in a same direction; and illumination means contained within said sign housing for illuminating said sign and said emergency light.

2. An assembly of claim 1 wherein said sign defines a peripheral boundary and wherein said perimetrical wall of said housing substantially co-extensively bounds said peripheral boundary.

3. An assembly of claim 1 wherein said emergency lighting fixture is pivotally mounted.

4. A combination exit sign and emergency lighting fixture assembly comprising:
an exit sign fixture including a sign housing having a perimetrical wall defining opposed faces transversely spaced apart a given distance and which support thereat in sealed relationship a pair of illuminable exit signs;
an emergency lighting fixture including at least one illuminable emergency light secured to said perimetrical wall, and a light housing sealingly secured to said perimetrical wall and enclosing said emergency light, said housing having a transverse dimension not exceeding said given distance between said opposed faces of said exit sign fixture; and
illumination means contained within said sign housing for illuminating said exit signs and said emergency light.

5. An assembly of claim 4 wherein said exit signs define a peripheral boundary and wherein said perimetrical wall of said housing substantially co-extensively bounds said peripheral boundary.

6. An assembly of claim 4 wherein said emergency lighting fixture is adjustably secured to said perimetrical wall of said fixture housing.

7. An assembly of claim 4 wherein said exit sign housing includes at least one mounting surface for mounting said fixture to a structure.

8. A combination sign and lighting fixture assembly comprising:
a sign housing including at least one sign therein, said sign housing having a dimension transverse to said sign;
a lighting fixture supported from said sign housing, said lighting fixture including at least one light source and a light housing, said lighting fixture having a transverse dimension approximately equal to or less than said transverse dimension of said sign housing.

9. An assembly as set forth in claim 8 wherein said light housing sealably encloses said light source.

10. An assembly as set forth in claim 8 wherein said light source is pivotally mounted within said light housing.

11. An assembly as set forth in claim 8 wherein said light source is an emergency light and wherein said sign is illuminated.

12. An assembly as set forth in claim 11 further comprising a power source for illuminating at least said light source.

13. An assembly as set forth in claim 12 wherein said power source is contained within said sign housing.
